(19) United States
(12) Patent Application Publication
(10) Pub. No.: US 2002/0097191 A1
(43) Pub. Date: Jul. 25, 2002

(54) Method and system for reducing cell interference

(75) Inventors: Haim Harel, New York, NY (US); Kenneth A. Kludt, San Jose, CA (US); Anthony J. Weiss, Tel Aviv (IL)

Correspondence Address: Baker Botts L.L.P., Suite 600, 2001 Ross Avenue, Dallas, TX, 75201-2980, US

(73) Assignee: Wireless Online, Inc.

(21) Appl. No.: 09/907,149

(22) Filed: Jul. 16, 2001

(30) Foreign Application Priority Data
Oct. 16, 2000 (IL) 139077

(51) Int. Cl. H01Q 1/12; H01Q 21/00

(52) U.S. Cl. 343/890; 343/891; 343/893

(57) ABSTRACT

An antenna tower adjusts a subscriber beam in elevation to reduce cell interference. The antenna tower includes vertically spaced antennas that generate a subscriber beam that may be precisely adjusted in elevation. The antenna tower may also periodically calibrate the subscriber beam in order to precisely point the subscriber beam in a desired direction.

### TECHNICAL FIELD OF THE INVENTION

This invention relates generally to the field of communications systems and more specifically to a method and system for reducing cell interference.

### BACKGROUND OF THE INVENTION

The rising use of communications systems has led to the increasing demand for more effective and efficient techniques for communicating signals. An antenna tower located in a cell site communicates a signal to a subscriber in the cell site. Signals from other antenna towers, however, may interfere with the communicated signal, resulting in degraded communication. Known methods for reducing cell site interference involve using a tall antenna tower to point a signal down to the subscriber. The angle at which the signal is pointed reduces cell site interference. These methods, however, are impractical because they require relatively tall antennas.

### SUMMARY OF THE INVENTION

In accordance with the present invention, a method and system for communicating signals are provided that substantially eliminate or reduce the disadvantages and problems associated with previously developed systems and methods. In general, the present invention reduces cell interference.

According to one embodiment, a system for communicating signals is disclosed that includes a first antenna and a second antenna. The second antenna is spaced apart from the first antenna in a substantially vertical direction. The first antenna and the second antenna generate a subscriber beam. A signal processor adjusts the subscriber beam in elevation to reduce cell site interference.

According to another embodiment, a method for communicating signals is disclosed. A subscriber beam is generated using a first antenna and a second antenna, where the second antenna is spaced apart from the first antenna in a substantially vertical direction. A signal processor is used to adjust the subscriber beam in elevation to reduce cell site interference.

According to still another embodiment, a system for communicating signals is disclosed. The system includes a first subscriber in a first cell and a second subscriber in a second cell. An antenna tower is located in the second cell. The antenna tower generates a subscriber beam and adjusts the subscriber beam in elevation to service the second subscriber while reducing interference for the first subscriber.

A technical advantage of the communication system is that the system reduces cell interference, thus improving the quality of communication. The communication system adjusts a subscriber beam in elevation in order to avoid cell interference. The communication system includes vertically spaced apart antennas that allow for precise adjustment of the subscriber beam in elevation to avoid interfering signals from other cells. Additional antennas may be used to reduce the nulls of the beam pattern generated by the antennas. The communication system may periodically calibrate the direction of the subscriber beam in order to properly adjust the subscriber beam to avoid cell interference.

Other technical advantages are readily apparent to one skilled in the art from the following figures, descriptions, and claims.

### BRIEF DESCRIPTION OF THE DRAWINGS

For a more complete understanding of the present invention and for further features and advantages, reference is now made to the following description, taken in conjunction with the accompanying drawings, in which:

FIG. 1 illustrates one embodiment of a communication system incorporating the present invention;

FIG. 2 illustrates a cell site and its associated subscriber beam in the communication system;

FIG. 3 illustrates cell sites in the communication system;

FIG. 4 illustrates cell sites in the communication system;

FIG. 5 is a schematic diagram of one embodiment of a cell site in the communication system;

FIG. 6 illustrates a beam pattern generated by the cell site;

FIG. 7 is a block diagram of one embodiment of a signal processor for the cell site;

FIG. 8 is a flowchart illustrating a method for communicating signals in the communication system; and

FIG. 9 is a flowchart illustrating a method for calibrating signals in the communication system.

### DETAILED DESCRIPTION OF THE DRAWINGS

FIG. 1 illustrates one embodiment of a communication system 100 that covers a contiguous area that is broken down into a series of overlapping cell sites, or cells, for example, cell sites 102a-c. According to one embodiment, each cell site 102a-c is surrounded by six adjacent cell sites. Other cell site patterns may be used without departing from the invention. In this particular embodiment, cell sites 102a-c are approximately the same size, and each cell site 102a-c is approximately circular with a radius r. Each cell site 102a-c has an antenna tower 104, 106, and 108, respectively, located at approximately the center of the cell site. Antenna tower 106 is located at point b of cell site 102b, and antenna tower 108 is located at point c of cell site 102c.

In one embodiment, antenna towers 104, 106, and 108 transmit signals to and receive signals from a subscriber's wireless device, for example, a cell phone, data phone, data device, portable computer, or any other suitable device capable of communicating information over a wireless link.

Each antenna tower 104, 106, and 108 is responsible for communicating signals within its own cell site 102a-c, respectively. Each antenna tower 104, 106, and 108 generates a subscriber beam with which a subscriber within the cell site may communicate with the tower. For this particular arrangement of cells, the distance between antenna towers 104 and 106 is approximately 1.94r, and the distance between antenna towers 104 and 108 is approximately 4.58r.

The antennas of antenna towers 104, 106, and 108 communicate signals at specific wavelengths or frequencies. Communication system 100 may employ a frequency reuse plan to reduce cell interference. However, if one antenna is too close to another antenna tower operating at the same frequency, cell site interference may result. Cell site interference may result from the interaction of signals from more than one antenna tower, which may result in the degradation of the signals.

In a particular embodiment, antenna tower 106 and antenna tower 104 may operate at different frequencies to reduce or effectively eliminate interference. Due to the limited bandwidth available for a frequency reuse plan, antenna towers 104 and 108 may share the same frequencies in communication system 10. Other reuse patterns may be used without departing from the invention. However, if antenna tower 104 communicates strong signals outside a radius of d, where d is the distance from antenna tower 104 to the closest edge of cell site 102c, cell site interference may result. This cell interference between cell sites operating at similar frequencies may be particularly troublesome for systems in hilly or mountainous terrain, for systems having a limited frequency reuse plan or bandwidth, and for systems employing higher power communications to support greater data communication bandwidth.

In one embodiment, one or more switches, access devices, or other suitable equipment (referred to generally as switch 110) coordinates and controls communications among a communication network 112 and antenna towers 104, 106, and 108. Communication network 112 may be a satellite, microwave, or other suitable wireline or wireless network, or a combination of the preceding. In a particular embodiment, switch 110 couples towers 104-108 to the public switch telephone network (PSTN). A network controller 114 controls and maintains communications network 112.

In operation, antenna tower 104 communicates signals to a subscriber in cell site 102a by generating a subscriber beam. Antenna tower 104 is required to communicate signals within a radius r, but the signals need to diminish outside of a radius d. If antenna tower 104 communicates strong signals outside of radius d, cell site interference may result between antenna tower 104 and antenna tower 108, which operates at the same frequency. To communicate with a subscriber in cell site 102a, antenna tower 104 generates a subscriber beam and adjusts the subscriber beam in elevation to reduce interference with cell site 102c, thus improving signal communication.

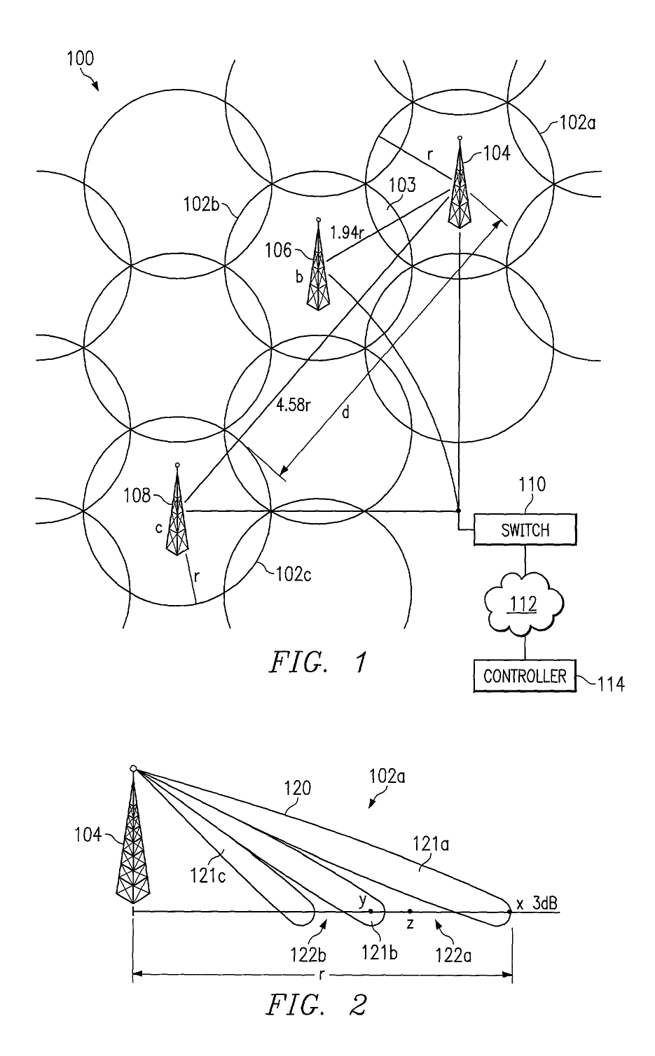

FIG. 2 illustrates a simplified diagram of a cell site 102a and its associated beam pattern 120 for communicating signals. FIG. 2 exaggerates the relative magnitude between the radius r of cell site 102a and the height of antenna tower 104 to illustrate the elevation adjustment concept. Antenna tower 104 generates beam pattern 120 that includes subscriber beams 121a-c. Beam 121a services a subscriber at point x located at the edge of cell site 102a, approximately a distance r from antenna tower 104. In order to service subscribers in cell site 102a while reducing interference with other cells, beam 121a may be directed in elevation to place its upper 3 dB dropoff gain at point x. The peak of beam 121a is the decibel measure of the antenna gain, and may be, for example, approximately 23 dB. Therefore, the gain provided at point x in this example would be approximately 20 dB. A subscriber at point y may be serviced by beam 121b.

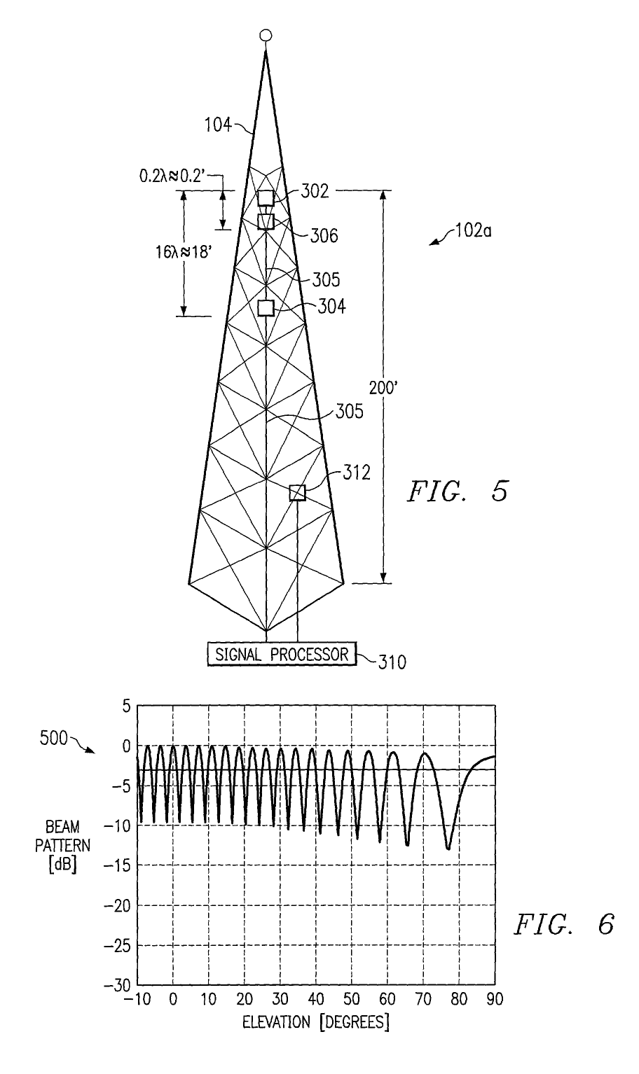

Nulls 122a-b are local minimums of beam pattern 120 between subscriber beams 121a-c, where beam pattern 120 experiences reduced gain. For example, subscriber beam 120 may not be able to service a subscriber located at point z of null 122a. Antenna tower 104 may use an antenna system discussed in more detail in connection with FIGS. 5 and 6 in order to reduce or truncate nulls 122a-b to provide continuous subscriber coverage at all distances from antenna tower 104.

FIG. 3 illustrates in more detail cell sites 102a and 102c with antenna towers 104 and 108, respectively, that operate at the same frequency. FIG. 3 exaggerates the relative magnitude between the radii of cell sites 102a and 102c and the heights of antenna towers 104 and 108 to illustrate the elevation adjustment concept. To avoid interference from signals from antenna tower 108, antenna tower 104 adjusts subscriber beam 121a in elevation to avoid signals from cell site 102c. The precision with which subscriber beam 121a should be adjusted may be computed from the height h of antenna tower 104 and distances d and r. In this embodiment, point p is the point at the edge of cell site 102a closest to antenna tower 108, and point q is the point at the edge of cell site 102c closest to antenna tower 104. Height h is the distance between point k and point j, r is the radius of cell sites 102a and 102c, and d is the distance between point k and point q. Antenna tower 104 broadcasts signals within radius r, but the signals need to diminish outside of radius d.

Angle α is the angle between the line from point j to point q and the line from point q to point k. Angle β is the angle between the line from point j to point p and the line from point p to point k. Angle δ is the angle between the line from point p to point j and the line from point j to point q. Angle δ may be used to determine the vertical precision needed to adjust subscriber beam 121a such that the beam 121a illuminates the area within radius r, but diminishes outside of radius d.

In one embodiment, height h of antenna tower 104 is two hundred feet, radius r of cell site 108 is five miles, and the distance d is twenty miles. If:

tan α=h/d, and

tan β=h/r, then

α=0.11°

β=0.43°

δ=β−α=0.32°

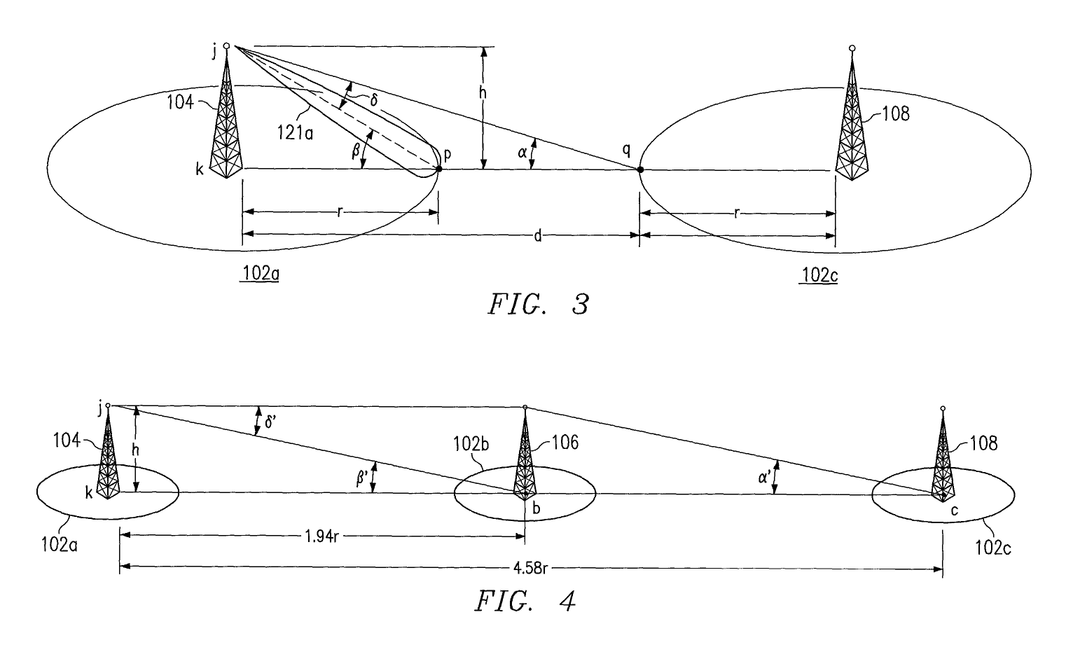

That is, subscriber beam 121a may need to be adjusted with a vertical precision of at least, for example, δ/5=0.064°. More or less precision may be required in some situations, for example, at least δ/10=0.032° or δ/2=0.16°. A tall antenna tower may be used to precisely adjust a subscriber beam. Such an antenna tower, however, may be impracticably large. Antenna tower 104 may precisely adjust a subscriber beam using a more practical antenna system discussed in more detail in connection with FIGS. 4 and 6.

According to one embodiment, antenna tower 104 calibrates subscriber beam 121a to compensate for the terrain and environment around antenna tower 104. Changes in the equipment resulting from, for example, environmental changes, may alter the direction of subscriber beam 121a, thus antenna tower 104 periodically calibrates subscriber beam 121a to adjust the direction of subscriber beam 121a. To calibrate subscriber beam 121a, ideally measurements at radius r and distance d may be taken. Calibration transmitters placed at radius r and distance d could emit calibration signals. Antenna tower 104 would then receive the calibration signals to determine the direction of the subscriber beam 121a and then adjust subscriber beam 121a in elevation accordingly.

Placing transmitters at radius r and distance d, however, may be impractical, because in general communication devices are not located at these locations. To estimate calibration measurements, calibration transmitters may be placed at antennas near radius r and distance d. Referring to FIG. 1, for example, instead of placing calibration transmitters at the edge of cell sites 102a and 102c, transmitters may be placed at antenna towers 106 and 108. Transmitters placed at antenna towers 106 and 108 yield approximations of measurements resulting from transmitters placed at radius r and distance d.

FIG. 4 illustrates cell sites 102a, 102b, and 102c with antenna towers 104, 106, and 108, respectively. FIG. 4 exaggerates the relative magnitude between the radii of cell sites 102a and 102c and the heights of antenna towers 104 and 108 to illustrate the elevation adjustment concept. Placing the calibration transmitters at antenna towers 106 and 108, however, requires more stringent beam width and pointing requirements. In the particular cell site scheme illustrated in FIG. 1, calibration transmitters are placed at point b at antenna tower 106 located 1.94r miles away from antenna tower 104, and at point c at antenna tower 108 located 4.58r away from antenna tower 104. Angle α′ is the angle between the line from point j to point c and the line from point c to point k. Angle β′ is the angle between the line from point j to point b and the line from point b to point k. Angle δ′ is the angle between the line from point b to point j and the line from point j to point c. If radius r is five miles, and h is 200 feet, then:

α′=0.22°

β′=0.09°, and

δ′=0.13°

That is, subscriber beam 121a may need to be adjusted with a vertical precision of, for example, at least δ′/5=0.026°. More or less precision may be needed in some situations, for example, at least δ′/10=0.013° or δ′/2=0.065°. An antenna tower for generating such a subscriber beam is discussed in more detail in connection with FIGS. 5 and 6.

FIG. 5 is a schematic diagram of one embodiment of a cell site 102a in the communication system that includes an antenna tower 104 for communicating signals. According to one embodiment, antenna tower 104 may be approximately two hundred feet high. Antenna tower 104 includes antennas 302 and 304 that operate at a specific wavelength and frequency to form a subscriber beam. Antennas 302 and 304 may be, for example, sixteen dipole 4×4 array antennas operating at a frequency of approximately 900 MHz and a wavelength of approximately 1.1 feet, and may be substantially vertically separated from each other by, for example, sixteen wavelengths. Antennas 302 and 304 are coupled to a signal processor 310 by, for example, a low loss coaxial cable 305. By using two antennas 302 and 304 vertically separated, antenna tower 104 generates a narrow subscriber beam that may be precisely pointed to avoid cell site interference, resulting in improved signal communication without requiring an impracticably tall antenna.

A third antenna 306, or more antennas, may be used to reduce the nulls between lobes in the subscriber beam. Antenna 306 may be placed relatively close to antenna 302, for example, less than one wavelength, for example, 0.2 wavelengths, away from antenna 302. Antenna 306 may also be coupled to signal processor 310 using coaxial cable 305. Third antenna 306 reduces the nulls of the beam pattern, as shown in FIG. 6. Reducing the nulls of the beam pattern allows for greater coverage of all site 102a, such that more subscribers may be serviced.

FIG. 6 illustrates one embodiment of a beam pattern 320 generated by cell site 102a having three vertically placed antennas 302, 304, and 306. First antenna 302 and second antenna 304 are approximately sixteen wavelengths apart, and third antenna 306 is approximately 0.2 wavelengths from first antenna 302. Beam pattern 320 exhibits reduced nulls, since the subscriber beam generates a signal (at least approximately the peak of the beam minus 10 dB) at all elevations. By using third antenna 306, antenna tower 104 reduces the nulls of the subscriber beam, resulting in more coverage for the cell site, thus improving signal communication.

Referring back to FIG. 5, antenna tower 104 may also include a transmitter 312 coupled to signal processor 310 that transmits a calibration signal. The calibration signal is used by antenna towers at other cell sites to calibrate their own subscriber beams.

In operation, antennas 302, 304, and 306 generate a subscriber beam to service cell site 102a. Signal processor 310 adjusts the subscriber beam in elevation to reduce cell site interference, resulting in improved signal communication. Antennas 302, 304, and 306, receive calibration signals, and transmit the signals to signal processor 310. Signal processor 310 determines an adjustment angle in response to the calibration signals, and then calibrates the subscriber beam using the adjustment angle, ensuring the high quality of signal communication. Transmitter 312 transmits a calibration signal used by antenna towers at other cell sites to calibrate their own subscriber beams.

FIG. 7 is a block diagram of one embodiment of a signal processor 310 for communicating signals. According to one embodiment, signal processor receives calibration signals, determines an adjustment angle, and adjusts a subscriber beam using the adjustment angle. Signal processor 310 includes a vector modulator 403, which in turn includes a phase-amplitude modulator 402 and a signal combiner 404. Vector modulator 403 receives input signals 401a-b from antennas 302 and 304, respectively. Phase-amplitude modulator 402 modulates the phase and amplitude of signals 401a-b in order to combine signals 402a-b. An array of attenuators may be used to vary amplitude, and switch delay lines may be used to vary phase. Alternatively, the signal may be divided into I/Q components. I/Q components may be controlled using attenuators, and I/Q components may be combined to vary phase shifting. Other suitable means of modulating the phase and amplitude of the signals may be used. Signal combiner 404 combines signals 401a-b using cancellation and/or enhancement techniques. Cancellation procedures attempt to reduce the noise of the combined signals, and enhancement procedures attempt to enhance the data of the combined signals. Any other suitable procedure to combine signals 401a-b may be used.

In one embodiment, signal processor 310 also includes a monitor 406 and a processing module 408. Monitor 406 receives the combined signals from signal combiner 404. Monitor 406 monitors the power of the combined signals and transmits the measurement of the power to processing module 408. Processing module 408 uses the information to construct a beam pattern of the subscriber beam 121a. Using the beam pattern, processing module 408 determines an adjustment angle of the beam in order to calibrate the beam. Processing module 408 may use a lookup table 410 located in a memory 412 to determine the adjustment angle from the beam pattern.

TABLE 1 illustrates one embodiment of lookup table 410.

TABLE 1

| | | | Angle |
|---|---|---|---|
| | First Signal x (dB) | Second Signal y (dB) | Adjustment (°) |
| 1 | 0 ≦ x < 1 | 0 ≦ y < 1 | −0.05 |
| 2 | 0 ≦ x < 1 | 1 ≦ y < 2 | −0.10 |
| 3 | 0 ≦ x < 1 | y ≧ 2 | −0.15 |
| 4 | 1 ≦ x < 2 | 0 ≦ y < 1 | 0 |
| 5 | 1 ≦ x < 2 | 1 ≦ y < 2 | −0.05 |
| 6 | 1 ≦ x < 2 | y ≧ 2 | −0.10 |
| 7 | x ≧ 2 | 0 ≦ y < 1 | +0.05 |
| 8 | x ≧ 2 | 1 ≦ y < 2 | 0 |
| 9 | x ≧ 2 | y ≧ 2 | −0.05 |

The first and second columns of TABLE 1 show the measurements of the first and second calibration signals, respectively. For example, first and second calibration signals are received from antenna towers 106 and 108, respectively. The third column shows the angle by which the subscriber beam needs to be adjusted based on the measurements. A positive angle adjustment indicates an upward adjustment, a negative angle adjustment indicates a downward adjustment, and a zero angle adjustment indicates no adjustment.

In this embodiment, the first calibration signal is stronger than the second calibration signal when subscriber beam 121a is properly calibrated, that is, when subscriber beam 121a is pointing in the desired direction. For example, line 4 of TABLE 1 indicates that if the strength of the first signal is greater than or equal to 1 dB and less than 2 dB and if the strength of the second signal is greater than or equal to 0 dB and less than 1 dB, then no angle adjustment is needed. Similarly, line 8 indicates that if the strength of the first signal is greater than or equal to 2 dB and if the strength of the second signal is greater than or equal to 1 dB and less than 2 dB, then no angle adjustment is needed.

If the first calibration signal is not strong enough, subscriber beam 121a needs to be pointed downward, as indicated by a negative angle adjustment. For example, in lines 1, 2, 3, 5, 6, and 9, the strength of the first calibration signal is not sufficiently greater than the strength of the second calibration signal, and TABLE 1 indicates that a negative angle adjustment is needed. If the first calibration signal is too strong, TABLE 1 indicates than that an upward adjustment of subscriber beam 121a is needed. For example, in line 7, the first calibration signal is too strong, and TABLE 1 indicates that a positive angle adjustment is needed.

Table 410 may be determined from the initial calibration of antenna tower 104. During the initial calibration, the position of subscriber beam 121a is measured, and the power of a first and a second calibration signal is determined by antenna 104. Repeated measurements of the position of subscriber beam 121a are associated with determinations of the power of the corresponding calibration signals to form table 410. Although shown using a lookup table based on calibration ranges, processing module 408 may use other empirical, algorithmic, or other suitable technique to generate an adjustment angle based on calibration signals.

Processing module 408 uses the adjustment angle to generate output signals 414a-b. Signals 414a-b form a subscriber beam that is calibrated in elevation to avoid cell site interference. Signal processor 401 provides fast, effective calibration of the subscriber beam, resulting in reduced signal interference and improved signal communication.

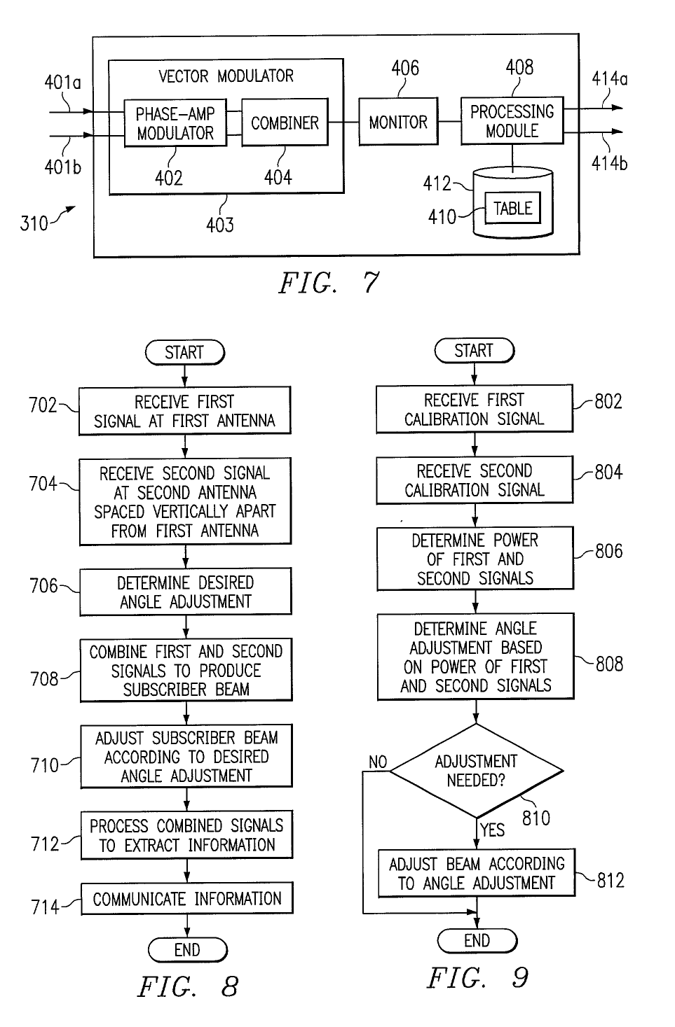

FIG. 8 is a flowchart describing a method for communicating signals in the communication system. Antenna tower 104 of cell site 102a generates a subscriber beam 121a and adjusts the subscriber beam 121a in elevation in order to reduce cell site interference.

The method begins at step 702, where antenna 302 receives a first signal. Antenna 302 is part of antenna tower 104. Antenna 304 of antenna tower 104 receives a second signal at step 704. Antenna 304 is spaced vertically apart from antenna 302. Signal processor determines a desired angle adjustment at step 706. One possible angle adjustment is described in more detail in connection with FIG. 9. Other suitable techniques of angle adjustment, for example, open loop adjustment, absolute adjustment, may be used. Antenna tower 104 generates subscriber beam 121a of beam pattern 120 at step 708. Antennas 302, 304, and 306 communicate signals that combine to form subscriber beam 121a. The signals from antennas 302 and 304 combine to form beam pattern 120 with narrow pencil beams, and the signal from antenna 306 reduces the nulls of beam pattern 120. Antenna tower 104 adjusts the subscriber beam at step 710 according to the angle adjustment.

Processing module 408 uses the adjustment angle to generate output signals 414a-b that form subscriber beam 121a that is calibrated in elevation to point in a desired direction, reducing cell site interference and improving signal communication. The received signals are combined, and information is extracted from the signals, at step 712. The received signals are transmitted to signal processor 310. Combiner 404 of signal processor 310 combines the signals, and processing module 408 extracts information from the signals. Signal processor 310 communicates the information at step 714. Signal processor 310 transmits the information to switch 110, which transmits the information to network 112. After signal processor 310 transmits the information, the method terminates.

FIG. 9 is a flowchart illustrating a method for calibrating signals in the communication system. According to one embodiment, antenna tower 104 receives calibration signals from antenna towers 106 and 108, determines an adjustment angle from the calibration signals, and calibrates subscriber beam 121a using the adjustment angle.

The method begins at step 802, where antenna tower 104 of cell site 102a receives a first calibration signal. Antenna tower 106 of cell site 102b transmits a calibration signal to antenna tower 104. The calibration signal from antenna tower 106 approximates a calibration signal sent from the edge of cell site 102a, the radius within which antenna tower 104 is required to transmit signals. Antenna tower 104 receives a second calibration signal at step 804. Antenna tower 108 of cell site 102c transmits the second calibration signal to antenna tower 104. The calibration signal from antenna tower 108 approximates a calibration signal sent from radius d, the radius beyond which antenna tower 104 is restricted from broadcasting strong signals.

Antenna tower 104 determines the power of the first and second calibration signals at step 806. The calibration signals are transmitted to signal processor 310. Signal processor 310 includes vector modulator 403, monitor 406, processing module 408, and lookup table 410. Vector modulator 403 adjusts the phases and amplitudes of calibration signals, and then combines the calibration signals. Monitor 406 measures the power of the combined calibration signals. Processing module 408 generates beam pattern 120 from the power to determine the direction of subscriber beam 121a. From the direction of subscriber beam 121a, processing module 408 determines an adjustment angle needed to point subscriber beam 121a in a desired direction, at step 808. Processing module uses table 410 to determine the adjustment angle, as described in connection with FIG. 7.

Antenna tower 104 determines whether an angle adjustment is needed at step 810. If an angle adjustment is not needed, the method terminates. If an angle adjustment is needed, the method proceeds to step 812. Antenna tower 104 calculates the antenna signals that generate subscriber beam 121a pointing in the desired direction, and adjusts subscriber beam 121a accordingly. Antenna tower generates subscriber beam 121a pointing in the desired direction to reduce cell site interference, resulting in improved signal communication, and the method terminates.

Although an embodiment of the invention and its advantages are described in detail, a person skilled in the art could make various alternations, additions, and omissions without departing from the spirit and scope of the present invention as defined by the appended claims.

What is claimed is:

1. A system for communicating signals, the system comprising:
a first antenna;
a second antenna spaced apart from the first antenna in a substantially vertical direction, wherein the first antenna and the second antenna generate a subscriber beam; and
a signal processor coupled to the first antenna and the second antenna and operable to adjust the subscriber beam in elevation to reduce cell site interference.

2. The system of claim 1, wherein the signal processor adjusts the subscriber beam with a precision of at least one-half of one degree.

3. The system of claim 1, wherein:
the first antenna operates at a wavelength; and
the distance between the first antenna and the second antenna is greater than ten wavelengths.

4. The system of claim 1, further comprising a third antenna located in proximity to the second antenna and operable to reduce a null of the subscriber beam.

5. The system of claim 4, wherein:
the first antenna operates at a wavelength; and
the distance between the second antenna and the third antenna is less than one wavelength.

6. The system of claim 1, wherein the first antenna is an array antenna.

7. The system of claim 1, wherein:
the system services a cell site having a radius; and
a subscriber at the approximate radius of the cell site receives the subscriber beam at approximately three decibels lower than a peak of the subscriber beam.

8. The system of claim 1, wherein the signal processor is operable to receive a calibration signal and to adjust the subscriber beam in response to the calibration signal.

9. The system of claim 8, wherein:
the signal processor further comprises a monitor operable to monitor the power of the calibration signal; and
the signal processor is operable to adjust the subscriber beam in response to the power of the calibration signal.

10. The system of claim 8, wherein the signal processor is operable to compute an adjustment angle from the calibration signal using a table and to adjust the subscriber beam according to the adjustment angle.

11. The system of claim 10, wherein the table comprises a plurality of entries, each entry specifying a range in a value of the calibration signal and a corresponding adjustment angle.

12. A method for communicating signals, the method comprising:
generating a subscriber beam using a first antenna and a second antenna spaced apart from the first antenna in a substantially vertical direction; and
adjusting the subscriber beam in elevation to reduce cell site interference using a signal processor coupled to the first antenna and the second antenna.

13. The method of claim 12, wherein adjusting comprises adjusting the subscriber beam with a precision of at least one-half of one degree.

14. The method of claim 12, wherein:
the first antenna operates at a wavelength; and
the second antenna is more than ten signal wavelengths apart from the first antenna.

15. The method of claim 12, wherein generating comprises generating the subscriber beam using the first antenna, the second antenna, and a third antenna, the third antenna operable to reduce a null of the subscriber beam.

16. The method of claim 15, wherein:
the first antenna operates at a wavelength; and
the third antenna is less than one wavelength away from the first antenna.

17. The method of claim 12, further comprising:
servicing a cell site having a radius and comprising the first antenna; and
receiving the subscriber beam at approximately three decibels lower than a peak of the subscriber beam by a subscriber at the approximate radius of the cell site.

18. The method of claim 12, wherein adjusting further comprises:
receiving a calibration signal; and
adjusting the subscriber beam in response to the calibration signal.

19. The method of claim 18, wherein adjusting further comprises:
monitoring the power of the calibration signal; and
adjusting the subscriber beam in response to the power of the calibration signal.

20. The method of claim 18, wherein adjusting further comprises:
determining an adjustment angle from the calibration signal using a table; and
adjusting the subscriber beam according to the adjustment angle.

21. The method of claim 20, wherein the table comprises a plurality of entries, each entry specifying a range in a value of the calibration signal and a corresponding adjustment angle.

22. A system for communicating signals, the system comprising:
a first subscriber in a first cell;
a second subscriber in a second cell; and
an antenna tower located in the second cell, the antenna tower operable to generate a subscriber beam and to adjust the subscriber beam in elevation to service the second subscriber while reducing interference for the first subscriber.

23. The system of claim 22, wherein the antenna tower adjusts the subscriber beam with a precision of at least one-half of one degree.

24. The system of claim 22, wherein:
the antenna tower comprises a first antenna and a second antenna spaced apart from the first antenna in a substantially vertical direction; and
the first antenna and the second antenna generate the subscriber beam.

25. The system of claim 24, wherein:
the first antenna operates at a wavelength; and
the distance between the first antenna and the second antenna is greater than ten wavelengths.

26. The system of claim 25, further comprising a third antenna, wherein the first antenna, the second antenna, and the third antenna generate the subscriber beam having reduced nulls.

27. The system of claim 26, wherein:
the first antenna operates at a wavelength; and
the distance between the second antenna and the third antenna is less than one wavelength.

28. The system of claim 22, wherein:
the second cell has a radius; and
the second subscriber is located at the approximate radius of the second cell.

29. The system of claim 28, wherein the second subscriber receives the subscriber beam at approximately three decibels lower than a peak of the subscriber beam.

30. The system of claim 22, wherein the antenna tower is operable to receive a calibration signal and to adjust the subscriber beam in response to the calibration signal.

31. The system of claim 30, wherein the antenna tower is operable to monitor the power of the calibration signal and to adjust the subscriber beam in response to the power of the calibration signal.

32. The system of claim 30, wherein the antenna tower is operable to determine an adjustment angle from the calibration signal using a table and to adjust the subscriber beam according to the adjustment angle.

33. The system of claim 32, wherein the table comprises a plurality of entries, each entry specifying a range in a value of the calibration signal and a corresponding adjustment angle.
